(19) United States
(12) Patent Application Publication
(10) Pub. No.: US 2022/0379288 A1
(43) Pub. Date: Dec. 1, 2022

(54) AN FCC CATALYST COMPOSITION AND A PROCESS FOR ITS PREPARATION

(71) Applicant: Reliance Industries Limited, Mumbai (IN)

(72) Inventors: Sankaranarayanan Thangaraju Murugan, Uyyakondan Thirumalai (IN); Ravichandran Gopal, Coimbatore (IN); Nirav Jethalal Jani, Bhavnagar (IN); Divakar Duraisamy, Salem (IN); Anuj Kumar, Bareilly (IN); Asit Kumar Das, Jamnagar (IN)

(73) Assignee: Reliance Industries Limited, Mumbai (IN)

(21) Appl. No.: 17/633,121

(22) PCT Filed: Oct. 3, 2020
(86) PCT No.: PCT/IB2020/059305

§ 371 Date: Feb. 4, 2022

(30) Foreign Application Priority Data
Oct. 4, 2019 (IN) 201921040377

(51) Int. Cl. B01J 29/08; B01J 21/16; B01J 21/12; B01J 35/10; B01J 35/02; B01J 35/00; B01J 35/08; B01J 37/04; B01J 37/00; B01J 37/08; B01J 37/02

(52) U.S. Cl. CPC B01J 29/088; B01J 29/084; B01J 21/16; B01J 21/12; B01J 35/1023; B01J 35/026; B01J 35/1038; B01J 35/1042; B01J 35/0026; B01J 35/08; B01J 37/04; B01J 37/0072; B01J 37/088; B01J 37/0203; B01J 37/0205; B01J 37/0236; C10G 11/05

(57) ABSTRACT

The present disclosure relates to an FCC catalyst composition and a process for its preparation. The FCC catalyst composition comprises Y type zeolite, silicon oxide, alumina, at least one clay, at least one rare earth metal, and at least one metal oxide. The FCC catalyst composition of the present disclosure provides improved yields of high value gasoline such as propylene and LPG and reduces yields of low value hydrocarbons such as CSO and LCO.

### FIELD

The present disclosure, relates FCC catalyst composition and a process for it preparation.

### DEFINITIONS

As used in the present disclosure, the following terms are generally intended to have the meaning as set forth below, except to the extent that the context in which they are used indicates otherwise.

Lower Coke Make: The term “Lower Coke Make” refers to the formationqy lower amount of coke during the hydrocracking operations.

Fluid Catalytic Cracking (FCC): The “fluid catalytic cracking” refers to a process used in petroleum refineries to convert the high-boiling, high-molecular weight hydrocarbon fractions of petroleum crude oils to more valuable gasoline, olefinic gases and other products.

FCC catalyst: The term “FCC catalyst” refers to a catalytic material that used in a fluidized bed catalytic process to convert a petroleum fraction primarily into a gasoline fraction.

Attrition loss rate: The term “Attrition loss rate” is defined as a catalyst loss due to physical abrasion, attrition, or grinding of catalyst particles during its use in the catalytic conversion cesses. The lower the attrition rate, the more attrition resistant are the catalyst particles.

Apparent bulk density: The term “Apparent bulk density” refers to a density determined by pouring a given amount of catalyst particles into a measuring device.

Clarified Slurry Oil (CSO): The term “Clarified Slurry Oil” refers to a heavy aromatic oil produced as a byproduct in an FCC unit, which ends up in the bottors of the fractionator.

Light Cycle Oil (LCO): The term “light cycle oil” refers to an unwanted liquid residue produced during the catalytic cracking of heavy hydrocarbon fractions from earlier stages of refining.

Y-type Zeolite: The term “Y-type zeolite” refers to a family of aluminosilicate molecular sieves with a faujasite-type structure (FAU), which is characterized by a higher silica to alumina (Si/Al) ratio.

Ultrastable Y Zeolite: The term “Ultrastable Y Zeolite” refers to a form of a Y-type zeolite in which the majority of sodium ions are removed and treated thermally to enhance its thermal and steam stability.

Unit Cell Size: The term “unit cell size” refers to predict the zeolite ro sties such as hydrothermal stability, total acidity, and acid strength.

Soda Content: The term “soda content” refers to the amount of sodium present in the zeolite of the catalyst composition.

### BACKGROUND

The background information herein below relates to the present disclosure but is not necessarily prior art.

In refining and petrochemical industry, “fluid catalytic cracking” (FCC) is used to convert the high-boiling, high-molecular weight hydrocarbon fractions of petroleum crude oils to more valuable gasoline, olefinic gases and other products. The FCC process employs a highly active micro-spherical catalyst comprising higher amount of Y type zeolite with active binder system to achieve a higher conversion of the high-molecular weight hydrocarbon fraction into gasoline. The catalytic activity of the FCC catalyst is predominantly a function of the number of acid sites present in the catalyst. However, the high activity generally results in low value products such as coke, clarified slurry oil (CSO) and dry gas, which are mostly undesired by-products of crude oil. To overcome the above drawbacks, conventionally the FCC catalyst is modified by controlling acid functionality of the matrix and use of higher amount of the zeolite in the catalyst composition.

Although, the yield of light olefins increases with increase in medium pore zeolites or catalyst to oil ratio and increase in the temperature, its formation is controlled by unimolecular Beta-scission mechanism which is well documented in literature. The change in the thermodynamic equilibrium by increasing the temperature leads to the formation of more dry gas due to over-cracking of light olefins. Hence, one of the challenge is to improve the light olefin yield, while minimizing the dry gas formation at higher conversion (>76 weight %) to increase refinery profit.

The development of an FCC catalyst for converting low value products from a hydrocarbon feed into high value products in the area of refining and petrochemicals is always of a commercial interest.

Therefore, there is felt a need to provide an FCC catalyst composition hat I ates the drawbacks mentioned herein above.

### OBJECTS

Some of the objects of the present disclosure, which at least one embodiment herein satisfies, are as follows:

An object of the present disclosure is to ameliorate one or more problems of the prior art or to at least provide a useful alternative.

Another object of the present disclosure is to provide an FCC catalyst composition.

Still another object of the present disclosure is to provide a process for preparing the FCC catalyst composition.

Yet another object of the present disclosure is to provide an FCC catalys for providing increased light olefin yield.

Still another object of the present disclosure is to provide an FCC catalyst composition that provides higher yields of propylene and LPG.

Another object of the present disclosure is to provide an FCC catalyst composition for converting low value hydrocarbons (CSO and LCO) to high value gasoline range molecules.

Other objects and advantages of the present disclosure will be amore apparent from the following description, which is not intended to limit the scope of the present disclosure.

### SUMMARY

The present disclosure provides an FCC catalyst composition comprising type zeolite, silicon oxide, alumina, at least one clay, at least one rare earth metal oxide, and at least one metal oxide.

The present disclosure further provides a process for preparing the FCC catalyst composition. The process comprises the step of mixing predetermined amounts of a Y type zeolite, a precursor of silicon oxide, a precursor of an alumina component, at least one dispersant, and at least one clay to obtain a slurry having a pH value in the range of 2.0 to 10.0. The slurry is spray dried to obtain a dried mass. The dried mass is calcined to obtain a calcined micro-spheroidal catalyst. The so obtained calcined micro-spheroidal catalyst is cooled to obtain a cooled calcined micro-spheroidal catalyst. The cooled calcined micro-spheroidal catalyst is treated with at least one organic compound at a temperature in the range of 20 to 40° C., for a time period in the range of 8 to 18 hours to obtain a treated micro-spheroidal catalyst. The treated micro--spheroidal catalyst is impregnated with a predetermined amount of a metal salt solution to obtain a metal impregnated micro-spheroidal catalyst. The metal impregnated micro-spheroidal catalyst is dried, followed by calcining to obtain a resultant catalyst. The resultant catalyst is treated with a predetermined amount of at least one rare earth metal compound, followed by filtering, drying, and calcining to obtain the FCC catalyst composition. The order of the process step of treating the cooled calcined micro-spheroidal catalyst with at least one organic compound and the process step of treating the resultant catalyst with a predetermined amount of at least one rare earth metal compound, is interchangeable.

### DETAILED DESCRIPTION

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, integers, steps, operations, elements, modules, units and/or components, but do not forbid the presence or addition of one or more other features, integers, steps, operations, elements, components, and/or groups thereof. The particular order of steps disclosed in the method and process of the present disclosure is not to be construed as necessarily requiring their performance as described or illustrated. It is also to be understood that additional or alternative steps may be employed.

FCC process employs a highly active micro-spherical catalyst to convert a high-molecular weight hydrocarbon into valuable products namely gasoline and lower olefin fractions. However, high activity of the FCC catalyst results in low value products such as coke, dry gas and sometimes clarified slurry oil (CSO), which are mostly undesired by-products of crude oil. To overcome these drawbacks, conventionally the FCC catalyst is modified by controlling acid functionality of the matrix and use of higher amount of zeolite in the catalyst composition.

The present disclosure provides an FCC catalyst composition to convert a high molecular weight hydrocarbon fractions into gasoline with improved light olefin yield, and also minimizes undesired low value products such as coke, clarified slurry oil (CSO) and dry gas.

The FCC catalyst composition of the present disclosure has enhanced efficacy and process reliability, longer catalytic life, and can be regenerated with ease and reused.

In a first aspect of the present disclosure, there is provided an FCC catalyst composition. The FCC catalyst composition comprises Y type zeolite, silicon oxide, alumina, at least one clay, at least one rare earth metal oxide, and at least one metal oxide.

The zeolite component in the FCC catalyst composition provides a catalytic activity to the catalyst.

In an embodiment of the present disclosure, the Y type zeolite is sodium free ultrastable (USY) zeolite. The Y-type zeolite is characterized by having a silica to alumina ratio (SAID) in the range of 5:1 to 15:1, an unit cell size (UCS) in the range of 24.25 to 24.65 Å, a surface area in the range of 600 to 950 m²/g and a soda content in the range of 0.001 to 0.5 weight %.

The activity of the catalyst is enhanced by incorporating the Y-type zeolite, which also provides greater stability to the FCC catalyst in the plant.

The alumina present in the catalyst composition is a highly porous aluminum oxide (Al₂O₃) and it is observed that any material which is highly porous, tends to have a very high surface-area to weight ratio.

Alumina and silica are used as binders in the FCC catalyst composition to provide mechanical strength by linking the zeolite crystallites, thereby resulting in an improvement in stability of the catalyst to resist physical breakdown. The binder's function and effect is realized only after it has gone through a physical and chemical transformation, that varies depending on the type of binder used.

In an embodiment, the clay is at least one selected from the group consisting of kaolin, montmorillonite, sapiolite, hallosite and bentonite. In an exemplary embodiment, the clay is kaoline.

The clay is used in the FCC catalyst composition as a filler material, to achieve desirable dispersion, porosity for better diffusion characteristics, and to increase particle density of the FCC catalyst particles.

In an embodiment, the rare earth metal oxide is at least one selected from the group consisiting of lanthanum oxide, cerium oxide, praseodymium oxide, and neodymium oxide. In an exemplary embodiment, rare earth metal oxide is lanthanum oxide.

The rare earth (RE) metal oxides present in the FCC catalyst composition enhances the hydrothermal stability of the FCC catalyst composition, and improves its conversion activity as a result of an increase in the strength of acid sites. However, RE also promotes hydrogen transfer activity and reduces the propylene yield. Therefore, desirable amount of RE is exchanged on Y-type zeolites to optimize the activity by minimizing hydrogen transfer.

In an embodiment, the metal oxide is at least one selected from the group consisting of aluminium oxide, rare earth oxides, molybdenum oxide, boron oxide, phosphorus oxide, tin oxide, and zirconium oxide. In an exemplary embodiment, the metal oxide is aluminum oxide. The metal oxide is located in the mesopores of the catalyst.

In accordance with present disclosure, the catalyst composition is characterized by having an average particle diameter in the range of 45μ to 180μ, a pore volume in the range of 0.3 g/cc to 0.5 g/cc, an attrition index in the range of 1 to 15 and a bulk density in the range of 0.65 to 0.80 g/cc.

In an embodiment, the FCC catalyst composition has the average particle diameter in the range of 70μ to 100μ, the pore volume in the range of 0.3 g/cc to 0.5 g/cc, the attrition index in the range of 7 to 9 and bulk density in the range of 0.65 to 0.80 g/cc.

In a second aspect of the present disclosure, there is provided a process for preparing the FCC catalyst composition. The process is described in details as follows:

Firstly, predetermined amounts of a Y type zeolite, a precursor of silicon oxide, a precursor of an alumina component, at least one dispersant, and at least one clay are mixed to obtain a slurry having a pH value in the range of 2.0 to 10.0.

In an embodiment of the present disclosure, the predetermined amount of Y type zeolite is in the range of 25 to 45 wt %, the predetermined amount of precursor of silicon oxide is in the range of 10 to 50 wt %, the predetermined amount of precursor of alumina is in the range of 5 to 45 wt %, the predetermined amount of dispersant is in the range of 0,25 to 0.75 and the predetermined amount of at least one clay is in the range of 5 to 40 wt %. The weight % of each of the component is with respect to the total weight of the FCC catalyst composition.

The step of mixing refers to homogenization of the catalyst components in the form of slurry. In addition to homogenization, the particle size reduction is also accomplished. Mixing can be achieved in either a batch mode or continuous circulation mode or combination of both.

In an embodiment, the precursor of silicon oxide is at least one selected from the group consisting of sodium free colloidal silica, fumed silica, and silicic acid. In an exemplary embodiment, the precursor of silicon oxide is sodium free colloidal silica.

In an embodiment, the precursor of alumina is at least one selected from the group consisting of pseudoboehmite, gamma-alumina, theta-alumina, alpha-alumina, aluminium nitrate, aluminium sulfate, poly aluminium chloride, and aluminium chlorohydrol. In an exemplary embodiment, the precursor of alumina is pseudoboehmite.

In an embodiment, the dispersant is at least one selected from the group consisting of sodium hexametaphosphate, sodium pyrophosphate, poly acrylic acid, and derivatives of poly acrylic acid. In an exemplary embodiment, the dispersant is sodium hexametaphosphate.

The dispersant promotes uniform suspension of the solid particles in a liquid phase.

In an embodiment, the slurry has a pH value in the range of 3 to 8. In an exemplary embodiment, the slurry has a pH value in the range of 5.5 to 6.5.

The slurry is spray dried to obtain a dried mass.

Spray drying involves atomization of catalyst composition in the form of slurry, followed by drying the atomized catalyst composition i an apparatus called spray dryer.

The dried mass is calcined to obtain a calcined micro-spheroidal catalyst.

In accordance with the present disclosure, the step of calcining the dried mass is carried out at a temperature in the range of 450° C. to 750° C., for a time period in the range of 0.5 to 6 hours. In an exemplary embodiment, the calcination carried out at 650° C. for 3 hours.

In accordance with the present disclosure, the particle size of the micro-spheroidal catalyst is in the range of 60 μm to 200 μm. In an exemplary embodiment, the particle size of micro-spheroidal catalyst is 95 μm.

The so obtained calcined micro-spheroidal catalyst is cooled at a temperature in the range of 20° C. to 40° C. to obtain a cooled calcined micro-spheroidal catalyst

Further, the cooled calcined micro -spheroidal catalyst is treated at least one organic compound at a temperature in the range of 20 to 40° C., for a time period in the range of 8 to 18 hours to obtain a treated micro-spheroidal catalyst.

In an embodiment, the calcined micro-spheroidal catalyst is treated with the organic compound at 30° C. for 15 hours to obtain the treated micro-spheroidal catalyst containing organic compound.

In accordance of the present disclosure, the organic compound is at least one selected from the group consisting of C₆ to C₁₆ alkanes, C₆ to C₁₆ alkenes, C₁ to C₁₀ alcohols, C₁ to C₁₀ polyols, and a base. In an embodiment, the organic compound is at least one selected from the group consisting of C₁ to C₁₀ alcohols, and C₁ to C₁₀ polyols.

The base is at least one selected from the group consisting of pyridine and pyridine derivatives. In an exemplary embodiment, the base is pyridine.

The organic compounds are used for selectively blocking the micro pores in the fresh FCC catalyst composition. As a result, when the micro pores are blocked, the FCC catalyst composition is impregnated with a metal salt solution, the metal salt will impregnate the mesopores of the catalyst composition. Thus, the step of selectively blocking the micro pores in the fresh FCC catalyst composition results in selectively modifying the matrix without affecting the zeolite micro pores.

A predetermined amount of a metal salt solution is impregnated on the treated micro-spheroidal catalyst to obtain a metal impregnated treated micro-spheroidal catalyst.

In accordance with the present disclosure, the step of treating and impregnating is carried out by incipient wetness method.

In an embodiment of the present disclosure, the metal salt solution is aqueous metal salt solution.

In an embodiment of the present disclosure, the predetermined amount of a metal salt solution is in the range of 0.1 to 5 wt %. The weight % of the metal salt solution is with respect to the total weight of the FCC catalyst composition.

In an embodiment of the present disclosure, the metal salt is at least one selected from the group consisting of aluminum nitrate, aluminum sulfate, aluminum acetate, aluminum chloride, and aluminum alkoxide. In an exemplary embodiment, the metal salt is aluminum nitrate.

The metal salt impregnated treated micro-spheroidal catalyst is dried followed by calcining to obtain a resultant catalyst.

The resultant catalyst is treated with a predetermined amount of at least one rare earth metal compound, followed by filtering, drying, and calcining to obtain the FCC catalyst composition.

In an embodiment of the present disclosure, the predetermined amount of at least one rare earth compound is in the range of 0.1 to 5 wt %. The weight% of at least one rare earth compound is with respect to the total weight of the FCC catalyst composition.

In an embodiment, the rare earth compound is at least one selected from the group consisting of lanthanum nitrate, cerium nitrate, praseodymium nitrate, and neodymium nitrate, in an exemplary embodiment, the rare earth compound is lanthanum nitrate.

In accordance with the present disclosure, the resultant catalyst is treated with the rare earth compound for a time period in the range of 0.5 to 2 hours, followed by filtering, drying at a temperature in the range of 80 to 120° C. and calcining at a temperature in the range of 450 to 650° C., for time period in the range of 0.5 and 6 hours to obtain the FCC catalyst composition.

In accordance with the present disclos , the FCC catalyst composition comprises rare earth metals in its oxide form.

The order of the process step of treating the cooled calcined micro-spheroidal catalyst with at least one organic compound and the process step of treating the resultant catalyst with the a predetermined amount of at least one rare earth metal compound, is interchangeable.

Further, the present disclosure provides a process for cracking a hydrocarbon feed by contacting the hydrocarbon feed with the FCC catalyst composition of the present disclosure to obtain high yields of high value gasoline range molecules and low yields of low value hydrocarbons (CSO and LCO).

The feed includes olefin streams selected from the group consisting of naphtha, gasoline, light cycle oil, vacuum gas oil, coker oil, oil residue hydrocarbons, other heavier hydrocarbon (>C5+), crude and combination thereof.

The cracking process by using the FCC catalyst composition of the present disclosure, provides lower LCO and reduces CSO yields.

The FCC process employs a highly active micro-spherical catalyst comprising higher amount of Y type zeolite with active binder system to achieve a higher conversion of the high-molecular weight hydrocarbon fraction into gasoline. The catalytic activity of the FCC catalyst is predominantly a function of the number of acid sites present in the catalyst. However, high activity generally results in low value products such as coke, clarified slurry oil (CSO) and dry gas, which are mostly undesired by products of crude oil. To a person skilled in the art, it is known that the yield of coke increases substantially with an increase in the conversion beyond 60 weight %. Although, the formation of coke is necessary to maintain the heat balance in an FCC operation, the excess amount of coke deactivates the catalyst and decreases catalyst circulation rate, leading to reduced conversion of the hydrocarbon feed.

In the present disclosure, organic compounds are employed for selectively blocking the micropores in the fresh FCC catalyst composition. As a result, when the micro pores are blocked, the FCC catalyst composition is impregnated with a metal salt solution, the metal salt will impregnate the micropores of the catalyst composition. Thus, the step of selectively blocking the micro pores in the fresh FCC catalyst composition results in selectively modifying the matrix without affecting the zeolite micropores.

It is observed that the conversion of high-molecular weight hydrocarbon into valuable products by using the FCC catalyst composition of the present disclosure, is increased by 0.7, the amount of the LC( )is increased by 0.5%, the amount of the CSO is reduced by 1.3%, the amount of the propylene is increased by 0.4%, the amount of the gasoline is increased by 0.4%, the amount of the LPG is increased by 0.4%, as compared to the conventional FCC catalyst composition. The LCO has increased by 0.5, since the CSO has reduced by 1. 3%, thus over all the benefit is 0.7%.

In the present disclosure, the increase in the amount of propylene can be attributed to the reduction in the hydrogen transfer reaction. The hydrogen transfer reaction leads to reduction of propylene to propane.

The FCC catalyst composition of the present disclosure has enhanced efficacy, longer catalytic life, and it can be regenerated with ease and can be reused.

The FCC catalyst composition of the present disclosure is effectively used for reducing coke, CSO and dry gas in the FCC process while improving the yields of gasoline and light olefin. The better performance of the catalyst composition is due to the method of preparing the FCC catalyst in which, selectively blocking the micropores is carried out in the fresh FCC catalyst composition, followed by impregnating the blocked pores with a metal salt solution.

It is well known that the formation of high coke during the FCC process is known to lower the life of the FCC catalyst, therefore the FCC catalyst of the present disclosure which reduces the amount of coke, increases the life of the FCC catalyst.

The FCC catalyst having poor attrition resistance produces more fines, leading to the reduced catalytic activity, and creates environmental as well as operational problems. Attrition resistance of the FCC catalyst is one of the key parameters to minimize loss of zeolite present in the FCC catalyst in an FCC operation. It is a challenge to achieve a desired level of attrition resistance for an FCC catalyst while accomplishing a desired level of catalytic activity.

The FCC catalyst composition of the present discosure has a desired particle size with appropriate bulk density and attrition resistance to maintain the fludization of all inventory without any fines generation. Hence, by using the FCC catalyst composition of the present disclosure, the FCC process can he smoothly carried out without necessiting any shutdown.

Therefore, the catalyst composition of the present disclosure provides benefits of long service life, thereby avoiding the frequent catalyst replacement and generation of huge solid waste. Further, the spent catalyst composition is easily regenerated and efficiently used for removing olefinic impurities from a hydrocarbon.

The foregoing description of the embodiments has been provided for purposes of illustration and not intended to limit the scope of the present disclosure. Individual components of a. particular embodiment are generally not limited to that particular embodiment, but, are interchangeable. Such variations are not to be regarded as a departure from the present disclosure, and all such modifications are considered to be within the scope of the present disclosure.

The present disclosure is further described in light of the following laboratory scale experiments which are set forth for illustration purpose only and not to be construed for limiting the scope of the disclosure. These laboratory scale experiments can be scaled up to industrial/commercial scale and the results obtained can be extrapolated to industrial/commercial scale.

### EXPERIMENTAL DETAILS

### EXAMPLE 1

### Preparation of Calcined Micro-Spheroidal Catalyst

732 g of sodium free USY zeolite, 2000 g of colloidal silica (30%), 417 g of pseudoboehmite alumina (67%), 7 g of sodium hexametaphosphate (dispersant), 611 g of kaolin (85%) were mixed to form a slurry having a pH of 4.5. The slurry was spray dried at outlet temperature of 180° C. and then calcined at 600° C. for 3 hours to obtain a calcined micro-spheroidal catalyst. The calcined micro-spheroidal catalysts were steam deactivated prior to evaluation.

### EXAMPLE 2

### Preparation of Calcined Micro-Spheroidal Catalyst

854 g of sodium free USY zeolite, 2333 g of sodium free colloidal silica (30%), 417 g of pseudoboehmite alumina (67%), 7 g of sodium hexametaphosphate (dispersant), 376 g of kaolin clay (85%) were mixed to form a slurry having a pH of 4.5. The slurry was spray dried at the out let temperature of 180° C. and then calcined at 600° C. for 3 hours to obtain a calcined micro-spheroidal catalyst. The calcined micro-spheroidal catalysts were steam deactivated prior to evaluation.

The physicochemical characteristics of calcined micro-spheroidal catalysts prepared in Example 1 and Example 2, are summarized in Table-1.

TABLE 1
Physicochemical characteristics of
calcined micro-spheroidal catalyst

| Sample description | Example-1 | Example-2 |
|---|---|---|
| Total Surface Area | 309 | 347 |
| (m²/g) | | |
| Zeolite Surface Area | 158 | 182 |
| (m²/g) | | |
| Total Pore Volume | 0.38 | 0.38 |
| (cc/g) | | |

Steam deactivated micro-spheroidal catalyst

| | | |
|---|---|---|
| Total Surface Area (S) | 177 | 209 |
| (m²/g) | | |
| Zeolite Surface Area (S) | 90 | 111 |
| m²/g | | |
| Total Pore Volume (S), | 0.30 | 0.31 |
| cc/g | | |
| Attrition Index, % | 9 | 7 |

From Table 1, it is evident that the steam deactivated calcined micro-spheroidal catalyst prepared in Example 2 (using sodium free colloidal silica) has greater total surface area (TSA (S), m²/g) and Zeolite surface area (ZSA (S) m²/g), in comparison with the total surface area (TSA (S), m²/g) and Zeolite surface area (ZSA (S) m²/g) of the team deactivated calcined micro-spheroidal catalyst prepared in Example 1 (using colloidal silica)

### Comparative Example 1

### Preparation of FCC Catalyst in Accordance with the Conventional Method of Impregnation

100 g of calcined micro-spheroidal catalyst, obtained in Example 1, were impregnated with 0.16 M solution of an aqueous aluminium nitrate to obtain aluminium impregnated micro-spheroidal catalyst, which were dried at 120° C. for 3 hr and then calcined at 550° C. for 3 hours to obtain a FCC catalyst.

### Example 3

### Preparation of FCC Catalyst Composition in Accordance with the Present Disclosure

100 g of calcined micro-spheroidal catalyst, obtained in Example 1, were treated with 0.002 mole of n-butanol /g catalyst and equilibrated in ambient temperature for 15 hours to obtain a micro-spheroidal catalyst comprising butanol. The micro-spheroidal catalyst comprising butanol were sequentially impregnated two times with an aqueous solution of aluminium nitrate salt 0.0012 mole/g catal_{y}st. After each aluminium nitrate salt impregnation, the aluminium nitrate salt impregnated micro-spheroidal catalyst were dried at 120° C. for 12 hours and then calcined at 550° C. for 3 hours to obtain a resultant catalyst.

The resultant catalyst was later treated with 2.33 g of lathanum nitrate salt solution to exchange H (hydrogen) of USY to obtain a FCC catalyst.

### Example 4

### Preparation of FCC Catalyst in Accordance with the Present Disclosure

Same experimental procedure was repeated as in Example 3, except the organic compound used was pyridine (base) instead of n-butanol.

### Example 5

### Preparation of FCC Catalyst in Accordance with the Present Disclosure

100 g of calcined micro-spheroidal catalyst, obtained in Example 2, were treated with 0,002 mole of n-butanol /g catalyst and equilibrated in ambient temperature for 15 hours to obtain a micro-spheroidal catalyst comprising butanol. The micro-spheroidal catalyst comprising butanol were sequentially impregnated two times with 0.0012 mole aqueous solution of aluminium nitrate salt/g. After each aluminium nitrate salt impregnation, the aluminium nitrate salt impregnated micro-spheroidal catalyst were dried at 120° C. for 12 hours and then calcined at 550° C. for 3 hours to obtain a resultant catalyst.

The resultant catalyst were later treated with 2.33 g of lanthanum nitrate salt solution to exchange H (hydrogen) of USY to obtain a FCC catalyst.

### Example 6

### Preparation of FCC Catalyst in Accordance with the Present Disclosure

The micro-spheroidal catalysts obtained in Example 2 were later treated with 46.5 g of lanthanum nitrate salt solution to exchange H (hydrogen) of USY to obtain RE-exchanged calcined micro-spheroidal catalyst. 100 g of RE-Exchanged calcined micro-spheroidal catalyst, were treated with 0.002 mole of n-butanol/g catalyst and equilibrated in ambient temperature for 15 hours. The micro-spheroidal catalyst comprising butanol were sequentially impregnated two times with 0.0012 mole aqueous solution of aluminium nirtrate salt/g catalyst. After each aluminium salt impregnation, the aluminium salt impregnated micro-spheroidal catalyst were dried at 120° C. for 12 hours and then calcined at 550° C. for 3 hours to obtain a FCC catalyst.

The physicochemical characteristics of FCC catalyst prepared in Examples 3, 4, 5 and 6, are compared with conventional FCC catalyst prepared in comparative example 1 and the results are summarized in Table-2. The activity data as obtained from ACE unit for catalysts prepared in Examples 3, 4, 5, 6 and conventional catalyst at constant catalyst to oil ratio 8 are compared with commercial base case catalyst and are presented in Table 4. All the catalysts were steam deactivated prior to evaluation.

TABLE 2
Physicochemical characterization of FCC catalyst
prepared in Examples 3 to 6 of the present disclosure

| | Comparative | | | | |
|---|---|---|---|---|---|
| | Example-1 | | | | |
| Sample | (Con- | | | | |
| description | ventional) | Example-3 | Example-4 | Example-5 | Example-6 |
| Total | 283 | 283 | 285 | 309 | 288 |
| Surface | | | | | |
| Area, m²/g | | | | | |
| Zeolite | 171 | 160 | 159 | 165 | 180 |
| Surface | | | | | |
| Area, m²/g | | | | | |
| Total Pore | 0.32 | 0.33 | 0.32 | 0.31 | 0.31 |
| Volume, | | | | | |
| cc/g | | | | | |

Steam deactivated FCC catalyst

| | | | | | |
|---|---|---|---|---|---|
| Total | 169 | 176 | 180 | 209 | 195 |
| Surface | | | | | |
| Area (S), | | | | | |
| m²/g | | | | | |
| Zeolite | 91 | 93 | 97 | 111 | 112 |
| Surface | | | | | |
| Area (S) | | | | | |
| m²/g | | | | | |
| Total Pore | 0.28 | 0.28 | 0.28 | 0.28 | 0.28 |
| Volume (S), | | | | | |
| cc/g | | | | | |
| Attrition | 9 | 9 | 9 | 7 | 7 |
| Index, % | | | | | |

It is clearly seen from Table-2, that the steam deactivated FCC catalysts prepared in Examples 3-6 of the present disclosure have greater total surface area (TSA (S), m²/g) and Zeolite surface area (ZSA (S) m²/g), in comparison with the total surface area (TSA (S), m²/g) and Zeolite surface area (ZSA (S) m²/g) of the steam deactivated conventional catalyst prepared in Comparative Example-1. Further, the total pore volume (TPV) of the steam deactivated FCC catalysts prepared in Examples 3-6 is preserved.

TABLE 3
Catalytic performance of micro-spheroidal catalyst (prepared in
Examples 1 and 2) compared with commercial catalyst.

| | Commercial | | |
|---|---|---|---|
| | base case | | |
| Sample description | catalyst | Example-1 | Example-2 |
| Conversion % | Base | 0.0 | 1.9 |
| Dry Gas | Base | 0.2 | −0.3 |
| LPG | Base | 0.6 | −0.2 |
| Propylene | Base | 0.4 | 0.2 |
| Gasoline | Base | −0.4 | 1.1 |
| LCO | Base | −0.7 | −0.6 |
| CSO | Base | 0.7 | −1.2 |
| Coke | Base | −0.5 | 1.2 |

* commercial base case catalyst is commercially known FCC catalyst

It is clearly seen from Table-3, that the catalytic performance at constant catalyst to oil ratio of 8 of the steam deactivated calcined micro-spheroidal catalysts of example 1 and 2, is at par with commercial catalyst. The catalyst composition as disclosed in example 2 had higher conversion when compared to the catalyst composition as disclosed in example due to higher zeolite content.

TABLE 4
Catalytic performance of Examples 3, 4, 5, and 6 and conventional catalyst
(comparitive example 1) compared with commercial catalyst.

| | Commercial | Comparative | | | | |
|---|---|---|---|---|---|---|
| Sample | base case | Example-1 | | | | |
| description | catalysts | (Conventional) | Example-3 | Example-4 | Example-5 | Example-6 |
| Conversion | Base | −3.7 | 0.0 | 0.0 | 1.1 | −1.0 |
| % | | | | | | |
| Dry Gas | Base | 1.4 | 0.2 | 0.0 | −0.2 | −0.4 |
| LPG | Base | 7.2 | −0.6 | −0.5 | 0.4 | −0.1 |
| Propylene | Base | 2.1 | 0.0 | −0.1 | 0.4 | −0.3 |
| Gasoline | Base | −6.8 | 1.1 | 1.4 | 0.4 | 0.6 |
| LCO | Base | −2.7 | 0.6 | 0.4 | 0.5 | 0.2 |
| CSO | Base | −2.4 | −0.5 | −0.4 | −1.3 | 0.5 |
| Coke | Base | 1.2 | −0.8 | −0.8 | −0.2 | −0.5 |

* commercial base case catalyst is commercially known FCC catalyst

It is clearly seen from Table-4, that the steam deactivated FCC catalysts prepared in Examples 3, 4, 5 and 6 of the present disclosure, improve theconversion, in comparison with commercial FCC catalysts and conventional FCC catalysts, which provide lower conversion of gasoline while providing increased amounts of coke and dry gas.

The values mentioned in Table-4 are in proportion to the values of commercial base case catalyst. The yield values are more in Examples 3-6 in reality if a person skilled in the art compare with the conversion of Comparative Example-1. There is a clear difference in the conversion of examples 3-6 as compared to comparative example 1.

### Technical Advancements

The present disclosure described hereinabove has several technical advantages including, but not limited to, the realization of FCC catalyst composition which:
reduces the amount of LCO and CSO;
has higher stability and selectivity; and
improves the yield of gasoline, propylene, and LPG.

The embodiments herein and the various features and advantageous details thereofare explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific errrbodimes so fully revealed the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The use of the expression “at least” or “at least one” suggests the use of one or more elements or ingredients or quantities, as the use may be in the embodiment of the disclosure to achieve one or more of the desired objects or results.

Any discussion of materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. An FCC catalyst composition comprising:
a. Y type zeolite;
b. silicon oxide;
c. alumina;
d. at least one clay;
e. at least one rare earth metal oxide; and
f. at least one metal oxide.

2. The catalyst composition as claimed in claim 1, wherein aid Y type zeolite s sodium free ultrastable Y (USY) zeolite.

3. The catalyst composition as claimed in claim 1, wherein said Y type zeolite is characterized by having:
i. a silica to alumina ratio (SARI in the range of 5:1 to 15:1;
ii. a unit cell size (UCS) in the range of 24.25 to 24.65Å;
iii. a surface area in the range of 600 to 950 m²/g; and
iv. a soda content in the range of 0.001 to 0.5 weight %;

4. The catalyst composition as claimed in claim 1, wherein said clay is at least one selected from the group consisting of kaolin, montmorillonite, sapiolite, hallosite and bentonite.

5. The catalyst composition as claimed in claim 1, wherein said metal oxide is selected from the group consisting of aluminium oxide, rare earth oxide, molybdenum oxide, boron oxide, phosphorus oxide, tin oxide, and zirconium oxide.

6. The catalyst composition as claimed in claim 1, wherein said rare earth metal oxide is at least one selected from the group consisting of lanthanum oxide, cerium oxide, praseodymium oxide, and neodymium oxide.

7. The catalyst composition as claimed in claim 1, wherein said catalyst composition is characterized by having:
i. an average particle diameter in the range of 45-180μ;
ii. a pore volume in the range of 0.3 g/cc to 0.5 g/cc;
iii. an attrition index in the range of 1 to 15; and
iv. a bulk density in the range of 0,65 to 0.80 g/cc.

8. A process for preparing the FCC catalyst composition, said process comprising the following steps:
a. mixing predetermined amounts of a Y type zeolite, a precursor of silicon oxide, a precursor of an alumina component, at least one dispersant, and at least one clay to obtain a slurry having a pH value in the range of 2.0 to 10.0;
b. spray drying said slurry to obtain a dried mass;
c. calcining said dried mass to obtain a calcined micro-spheroidal catalyst;
d. cooling said calcined micro-spheroidal catalyst at a temperature in the range of 20° C. to 40° C. to obtain a cooled calcined micro-spheroidal catalyst;
e. treating said cooled calcined spheroidal catalyst with at least one organic compound at a temperature in the range of 20 to 40° C., for a time period in the range of 8 to 18 hours to obtain a treated micro-spheroidal catalyst;
f. impregnating a predetermined amount of a metal salt solution on said treated micro-spheroidal catalyst to obtain a metal impregnated treated micro-spheroidal catalyst;
g. drying said metal salt impregnated treated micro-spheroidal catalyst followed by calcining to obtain a resultant catalyst; and
h. treating said resultant catalyst with a predetermined amount of at least one rare earth metal compound, followed by filtering, drying, and calcining to obtain said FCC catalyst composition
wherein the order of process steps (e) and (h) are interchangeable.

9. The process as claimed in claim 8, wherein said predetermined amountof
a. said Y type zeolite is in the range of 25 to 45 wt % with respect to the total weight of the FCC catalyst composition;
b. said precursor of silicon oxide is in the range of 10 to 50 wt % with respect to the total weight of the FCC catalyst composition;
c. said precursor of alumina is in the range of 5 to 45 wt % with respect to the total weight of the FCC catalyst composition;
d. said dispersant is in the range of 0.25 to 0.75 wt % with respect to the total weight of the FCC catalyst composition;
e. said at least one clay is in the range of 5 to 40 wt % with respect to the total weight of the FCC catalyst composition;
said at least one metal. salt is in the range of 0.1 to 5 wt % respect to the total weight of the FCC catalyst composition; and
g. said at least one rare earth compound is in the range of 0.1 to 5 wt % with respect to the total weight of the FCC catalyst composition;

10. The process as claimed in claim 8, wherein said precursor of silicon oxide is at least one selected from the group consisting of sodium free colloidal silica, fumed silica, and silicic acid.

11. The process as claimed in claim 8, wherein said precursor of alumina is at least one selected from the group consisting of pseudoboehmite, gamma-alumina, theta-alumina, alpha-alumina, aluminium nitrate, aluminium sulfate, poly aluminium chloride, and aluminium chlorohydrol.

12. The process as claimed in claim 8, wherein said clay is at least one selected from the group consisting of kaolin, montmorillonite, sapiolite, hallosite, and bentonite.

13. The process as claimed in claim 8, wherein said dispersant is at least one selected from. the group consisting of sodium hex ametaphosphate, sodium pyrophosphate, poly acrylic acid, and derivatives of poly acrylic acid.

14. The process as claimed in claim 8, wherein the particle size of said calcined micro-spheroidal catalyst obtained in step (c), is in the range of 60 μm to 200 μm.

15. The process as claimed in claim 8, wherein the step of calcining said dried mass in step (c) is carried out at a temperature in the range of 450° C. to 750° C., for a time period in the range of 0.5 to 6 hours.

16. The process as claimed in claim 8, wherein said organic compound is at least one selected from the group consisting of C₆ to C₁₆ alkanes, C₆ to C₁₆ alkenes, C₁ to C₁₀ alcohols, C₁ to C₁₀ polyols, and a base.

17. The process as claimed in claim 8, wherein said organic compound is at least one selected from the group consisting of C₁ to C₁₀ alcohols, and C₁ to C₁₀ polyols.

18. The process as claimed in claim 16, wherein said. base is at least one selected from the group consisting of pyridine and pyridine derivatives.

19. The process as claimed in claim 8, wherein said metal salt is at least one selected from the group consisting of aluminum nitrate, aluminum sulfate, aluminum acetate, aluminum chloride, and aluminum alkoxide.

20. The process as claimed in claim 8, wherein said rare earth metal compound is at least one selected from the group consisting of lanthanum nitrate, cerium nitrate, praseodymium nitrate, and neodymium nitrate.

21. The process as claimed in claim 8, wherein said. resultant catalyst is treated with said. rare earth compound for a time period in the range of 0.5 to 2 hours, followed by filtering, drying at a temperature in the range of 80 to 120° C. and calcining at a temperature in the range of 450 to 650° C. for a time period in the range of 0.5 and 6 hours to obtain the FCC catalyst composition.
